(19) United States
(12) Patent Application Publication
(10) Pub. No.: US 2026/0109020 A1
(43) Pub. Date: Apr. 23, 2026

(54) MAGNETIC TIP DEVICE

(71) Applicant: Timothy Chambers, Michigan City, IN (US)

(72) Inventor: Timothy Chambers, Michigan City, IN (US)

(21) Appl. No.: 18/923,217

(22) Filed: Oct. 22, 2024

(51) Int. Cl. B25J 1/04; B25J 15/06

(52) U.S. Cl. CPC B25J 1/04; B25J 15/0608

(57) ABSTRACT

A magnetic tip device for providing a magnet at an end of a shaft or similar implement to facilitate retrieving metal items includes a base having a planar bottom surface. A well extends into the base defining an interior wall for frictionally engaging a shaft of a walking assistance implement to couple the base to the shaft. A disc is coupled to the base. The disc is a magnet for magnetic engagement to an object allowing the object to be lifted by manipulation of the shaft.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to shaft tip device and more particularly pertains to a new shaft tip device for providing a magnet at an end of a shaft or similar implement to facilitate retrieving metal items.

### (2) Description of Related Art including information disclosed under 37 CFR 1.97 and 1.98

The prior art relates to shaft tip devices to enhance frictional engagement on a support surface to avoid slipping of the shaft on the surface. Known shaft tip devices do not provide a magnetic disc protruding from a bottom surface of the shaft tip.

### BRIEF SUMMARY OF THE INVENTION

An embodiment of the disclosure meets the needs presented above by generally comprising a base having a planar bottom surface. A well extends into the base defining an interior wall for frictionally engaging a shaft of a walking assistance implement to couple the base to the shaft. A disc is coupled to the base protruding from the bottom surface of the base. The disc is a magnet for magnetic engagement to an object allowing the object to be lifted by manipulation of the shaft.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a magnetic tip device according to an embodiment of the disclosure.

FIG. 2 is a rear view of an embodiment of the disclosure.

FIG. 3 is a right side view of an embodiment of the disclosure.

FIG. 4 is a left side view of an embodiment of the disclosure.

FIG. 5 is a top view of an embodiment of the disclosure.

FIG. 6 is a bottom view of an embodiment of the disclosure.

FIG. 7 is a top front side perspective view of an embodiment of the disclosure.

FIG. 8 is a side perspective view of an embodiment of the disclosure in use.

### DETAILED DESCRIPTION OF THE INVENTION

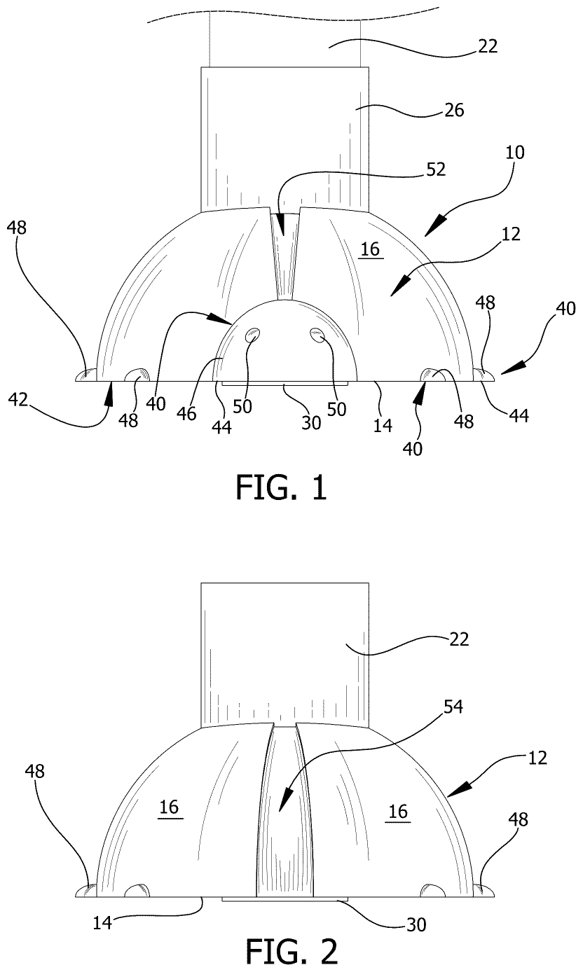

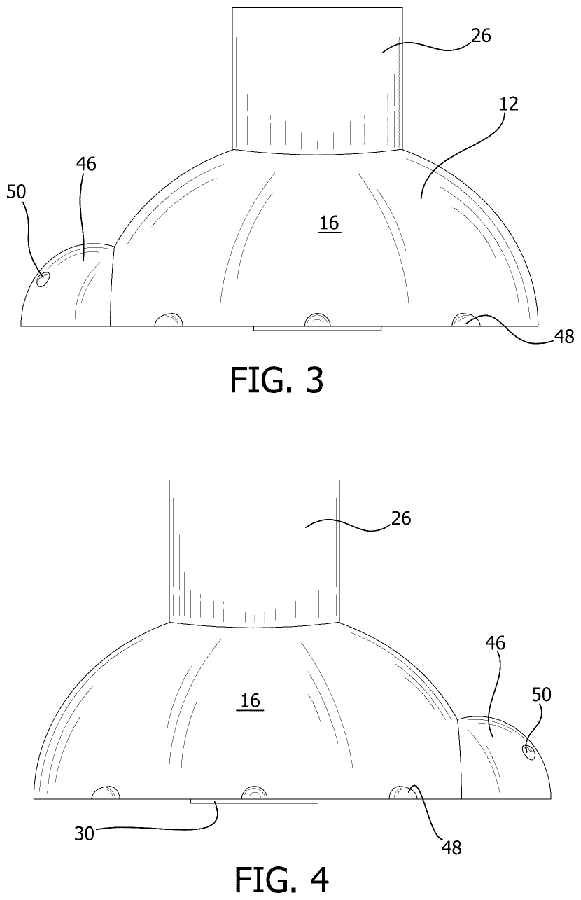

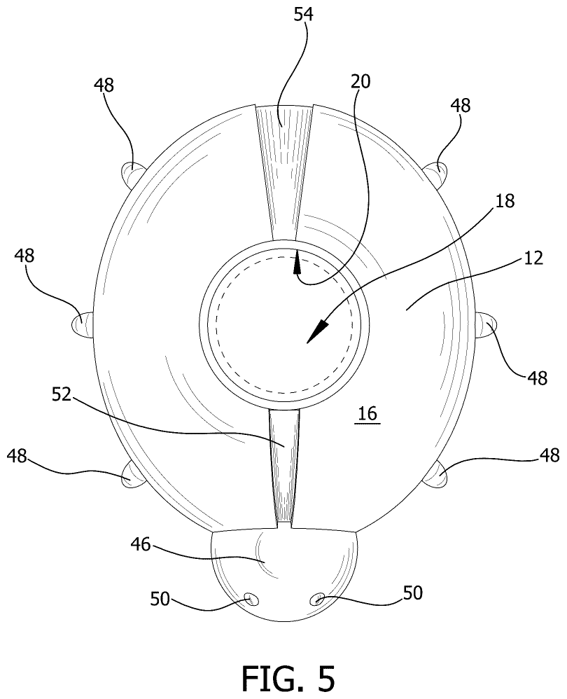

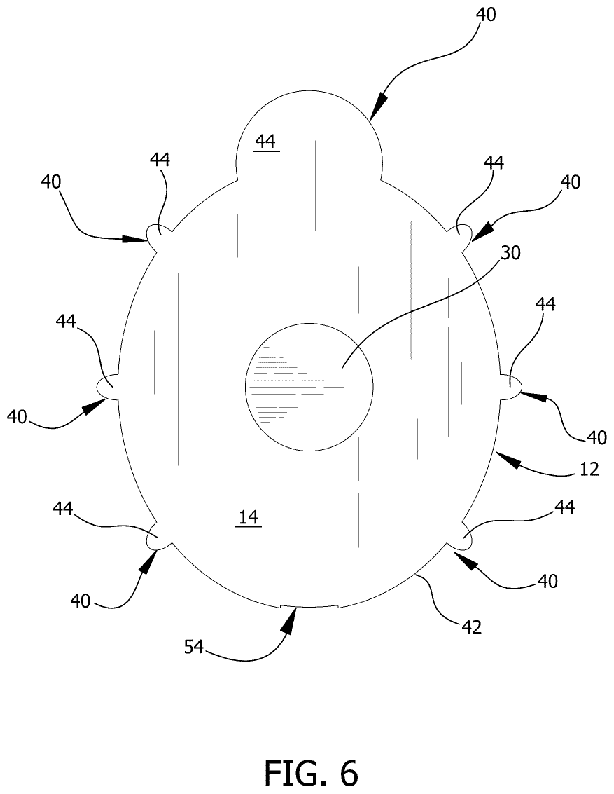

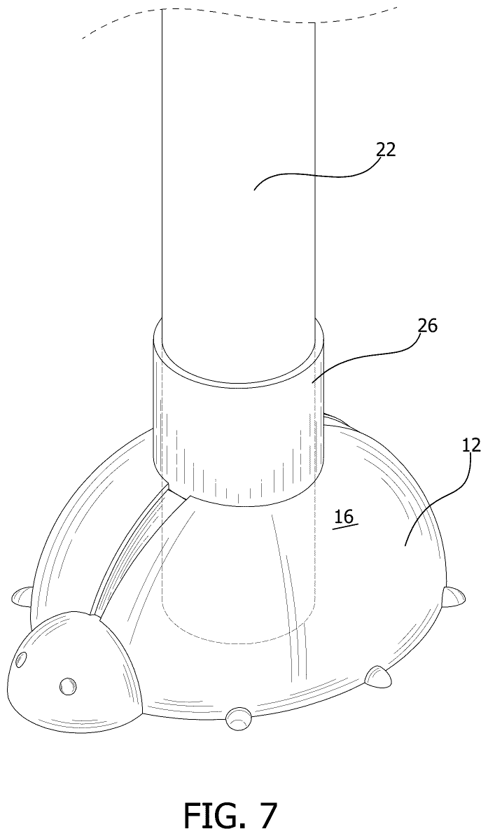

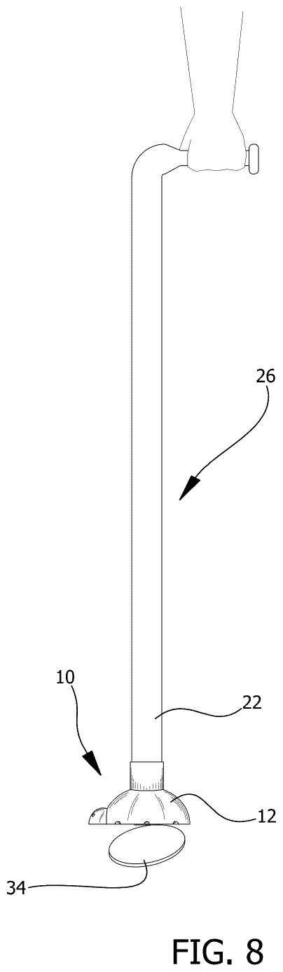

With reference now to the drawings, and in particular to FIGS. 1 through 8 thereof, a new shaft tip device embodying the principles and concepts of an embodiment of the disclosure and generally designated by the reference numeral 10 will be described.

As best illustrated in FIGS. 1 through 8, the magnetic tip device 10 generally comprises a base 12 having a planar bottom surface 14 and a curved upper surface 16 such that the base 12 is dome shaped. A well 18 extends into the base 12. The well 18 defines an interior wall 20 configured for frictionally engaging a shaft 22 of a walking assistance implement 24 such as a cane, walking stick, or the like. The base 12 is coupled to the shaft 22 by frictional engagement to the interior wall 20 of the well 18. As the shaft 22 would generally be cylindrical the well 18 would also be cylindrical, but could be otherwise shaped to be complementary to a different shaft shape. The base 20 may be constructed of a resiliently compressible or resiliently deformable material such as natural or synthetic rubber, or the like.

A cylindrical wall 26 extends upwardly from the upper surface 16 of the base 12. The cylindrical wall 26 is aligned with and extends from the well 18 upwardly from the base 12. This enhances or lengthens the frictional contact with the shaft 22. Further, the upper surface 16 of the base extending away from the cylindrical wall 26 can be used to enhance grip to facilitate removal of the base 12 from the shaft 22 when desired.

A disc 30 is coupled to the base 12. The disc 30 protrudes from the bottom surface 14 of the base 12. The disc 30 is a magnet such that the disc 30 is configured for magnetic engagement to an object 34. Thus, manipulation of the shaft 22 to position the base 12, and thus the disc 30, adjacent to the object 34, will facilitate picking up the object 34 without having to bend over. Additionally, the device 10 facilitates retrieval or picking up the object 34 if the object 34 has fallen behind, between, or into something where manual retrieval may be difficult. The disc 30 is oriented perpendicular to a central axis of the well 18 and the disc 30 is concentric with the central axis of the well 18. The disc 30 protrudes from the bottom surface 14 of the base 12 when coupled to the base 12 and no force is being exerted on the base 12 to urge the base down around the disc 30. The material of the base, as noted above, may be resiliently deformable such that the bottom surface 14 of the base 12 is urged down and around the disc 30 when downward pressure is exerted on the base 12 from the shaft 22.

Each of a plurality of nubs 40 is coupled to the base 12. The plurality of nubs 40 is radially arranged around a peripheral edge 42 of the bottom surface 14 of the base 12. Each nub 40 of the plurality of nubs 40 has a planar bottom face 44. The planar bottom face 44 of each nub 40 of the plurality of nubs 40 is coplanar with the bottom surface 14 of the base 12. The plurality of nubs 40 includes a head nub 46 and a plurality of leg nubs 48. The head nub 46 is sized larger than each of the leg nubs 48. A pair of eye indicia 50 is positioned on the head nub 46. There may be six leg nubs 48 arranged into sets of three leg nubs 48 on each side of the base 12 and evenly spaced to provide an appearance of an insect. Further, the positioning and array of the nubs 40 effectively broadens the base 12 to enhance stability and further prevent slipping of the base 12 during use of the walking assistance implement 24. There may also be a forward slot 52 in the upper surface 16 of the base 12 extending up and flaring outwardly from the head nub 46 such that the forward slot 52 is tapered and the upper surface 16 on opposing sides of the forward slot 52 resembles insect wings. A rear slot 54 may be positioned substantially diametrically opposed to the forward slot 52 extending fully from the peripheral edge 42 of the bottom surface 14 to the cylindrical wall 26.

In use, the base 12 is coupled to the shaft 22 by insertion of the shaft 22 into the well 18. The shaft 22 may then be manipulated to position the disc 30 adjacent to the object 34 such that the object 34 is magnetically attracted to the disc 30 allowing the object 34 to be lifted and moved with movement of the shaft 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A magnetic tip device comprising:
a base, said base having a planar bottom surface;
a well extending into said base, said well defining an interior wall configured for frictionally engaging a shaft whereby said base is coupled to the shaft;
a disc coupled to said base, said disc being a magnet wherein said disc is configured for magnetic engagement to an object.

2. The magnetic tip device of claim 1, further comprising:
said well being cylindrical; and
said disc being oriented perpendicular to a central axis of said well.

3. The magnetic tip device of claim 2, further comprising said disc being concentric with said central axis of said well.

4. The magnetic tip device of claim 1, further comprising a plurality of nubs coupled to said base, said plurality of nubs being radially arranged around a peripheral edge of said bottom surface of said base.

5. The magnetic tip device of claim 4, further comprising said plurality of nubs including a head nub and a plurality of leg nubs, said head nub being sized larger than each of said leg nubs.

6. The magnetic tip device of claim 5, further comprising a pair of eye indicia positioned on said head nub.

7. The magnetic tip device of claim 1, further comprising a cylindrical wall extending upwardly from said base, said cylindrical wall being aligned with and extending said well upwardly from said base.

8. The magnetic tip device of claim 1, further comprising said base having a curved upper surface such that said base is dome shaped.

9. The magnetic tip device of claim 4, further comprising each nub of said plurality of nubs having a planar bottom face.

10. The magnetic tip device of claim 9, further comprising said planar bottom face of each nub of said plurality of nubs being coplanar with said bottom surface of said base.

11. The magnetic tip device of claim 1, further comprising said disc protruding from said bottom surface of said base when coupled to said base.

12. A magnetic tip device comprising:
a base, said base having a planar bottom surface, said base having a curved upper surface such that said base is dome shaped;
a well extending into said base, said well defining an interior wall configured for frictionally engaging a shaft of a walking assistance implement whereby said base is coupled to the shaft, said well being cylindrical;
a cylindrical wall extending upwardly from said base, said cylindrical wall being aligned with and extending said well upwardly from said base;
a disc coupled to said base, said disc protruding from said bottom surface of said base, said disc being a magnet wherein said disc is configured for magnetic engagement to an object, said disc being oriented perpendicular to a central axis of said well, said disc being concentric with said central axis of said well;
a plurality of nubs coupled to said base, said plurality of nubs being radially arranged around a peripheral edge of said bottom surface of said base, each nub of said plurality of nubs having a planar bottom face, said planar bottom face of each nub of said plurality of nubs being coplanar with said bottom surface of said base, said plurality of nubs including a head nub and a plurality of leg nubs, said head nub being sized larger than each of said leg nubs; and
a pair of eye indicia positioned on said head nub.
